(19) United States
(12) Patent Application Publication
(10) Pub. No.: US 2004/0037288 A1
(43) Pub. Date: Feb. 26, 2004

(54) Control unit in a private atm terminal installation

(76) Inventors: Fabrice Bourgart, Perros Guirec (FR); Gilles Ramel, Lannon (FR); Regis Coat, Plouisy (FR); Bruno Le Corre, Lannon (FR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/344,140

(22) PCT Filed: Oct. 1, 2001
(86) PCT No.: PCT/FR01/03030

(30) Foreign Application Priority Data
Oct. 6, 2000 (FR) 00/12903

(51) Int. Cl. H04L 12/28

(52) U.S. Cl. 370/395.1; 370/230

(57) ABSTRACT

In a terminal installation (1), a control center (3) is connected to a router (2) between ATM access networks (RA₁-RA_{M}) and mainly individual installations (4) of terminals (7) and shared terminals (13). The control center manages identification of the terminals and routing addresses to route communications from and to terminals. Display of functions of each terminal to the other terminals and location of each terminal in the installation are managed in the form of a directory used to draw up a list of terminals having a requested common function depending on access rights by a calling terminal.

The present invention is generally concerned with asynchronous transfer mode private terminal installations installed on clients' premises.

The present invention concerns more particularly the management of terminals in a collective installation grouping together a plurality of individual ATM installations, such as the installation described in French patent application 99-07172 filed Jun. 8, 1999, not yet published. A multiterminal individual installation is connected to a telecommunication line conveying ATM network cells and includes broadcasting means for broadcasting all cells received via the receive channel of the telecommunication line to the terminals and means for collecting cells sent by the terminals via the send channel of the telecommunication line.

Also known in the art are home automation installations in which a control center is coupled to a private telephone central station and manages home automation terminals using power line carrier transmission on the wires of the private electrical power installation and/or short-range radio transmission.

The present invention aims to provide a control center for a private collective terminal installation, rather than an individual terminal installation, which manages routing aspects in addition to identification, function presentation and location aspects of the terminals by communicating exclusively in ATM mode with the terminals and a central collective router.

Accordingly, a control center for an ATM terminal installation connected by a reserved telecommunication line to a router between external telecommunication lines of ATM access networks and telecommunication lines internal to the installation servicing terminals, is characterized in that it comprises:

means for detecting and storing terminal identifiers and port numbers in incoming cells sent by the terminals and reserved for the control center, the port number of a terminal designating the internal line servicing at least the terminal,

means for allocating a class indicator to each terminal depending on functions offered by the latter and storing it, after a first activation of the terminal, and

means for drawing up a list of terminals with the class indicators and location indicators of the terminals in order to transmit it in an outgoing cell from the control center to a calling terminal that has sent an incoming cell containing a request for terminals offering at least one predetermined function.

The control center manages not only identification, offering of functions and location of terminals, but also the rights of requesting persons or terminals to access requested functions, such as services or applications. The control center includes then means for allocating to each terminal access rights entered into the control center after first activating the terminal in the terminal installation, and storing them in memory, in order to compare the access rights of the calling terminal with the class indicators stored in memory and to draw up the list only for terminals offering class indicators compatible with the access rights of the calling terminal and covering the predetermined function.

A means is especially forecast in the control center for selecting, managing and controlling home automation terminals in the terminal installation.

At this end, the control center includes means for processing incoming cells entering the control center and transmitting outgoing cells from the control center in an order of priority of the routing addresses that the cells contain. More precisely, the control center comprises a table memory for matching priority indicators and routing addresses contained in the routing address field of incoming and outgoing cells incoming to and outgoing from the control center and reserved for calls with the control center, means for comparing the routing address fields of the incoming cells to the reserved routing addresses read in the table memory, first buffers for storing each incoming cell respectively as a function of the priority indicator corresponding to the routing address contained in the incoming cell, cell processing means for processing the incoming cells by starting with those contained in the first buffers addressed by the highest priority indicators, means for comparing the routing address fields of the outgoing cells produced by the processing means to the reserved routing addresses read in the table memory, second buffers for storing each outgoing cell respectively as a function of the priority indicator matching the routing address contained in the outgoing cell, and means for sending the outgoing cells by starting with those contained in the second buffers associated with the highest priority indicators.

The invention also concerns an ATM terminal installation comprising a control center and a router connected to the control center by a reserved telecommunication line, to ATM access networks by a plurality of external telecommunication lines and to ATM terminals by internal telecommunication lines. The terminal installation is characterized in that the router routes to the reserved line cells which contain reserved routing addresses and routing addresses unknown to a routing table stored in the router and which are transmitted by the terminals and the access networks and routes cells containing routing addresses known by the routing table between the internal lines and the external lines and between the internal lines, and the control center comprises means for managing the routing table in order to process cells containing reserved routing addresses routed to the reserved line and to match unreserved routing addresses included in cells received by the router to unreserved routing addresses to be included in cells to be sent from the router.

To be more specific, to impose the mandatory direction to the control center of cells containing reserved routing addresses received by the router, in order for the control center to respond to the terminals that sent the cells, the router comprises means for detecting reserved routing addresses and routing addresses unknown to the routing table in cells received by the router, means for substituting reserved routing addresses for the unknown routing addresses in the received cells, means for marking the data field of each cell containing a reserved routing address with a number of a port of origin of the router via which the cell was received, and means for routing all the marked cells to the control center via the reserved line.

Other features and advantages of the present invention will become more clearly apparent on reading the following description of plural preferred embodiments of the invention, which description is given with reference to the corresponding accompanying drawings, in which:

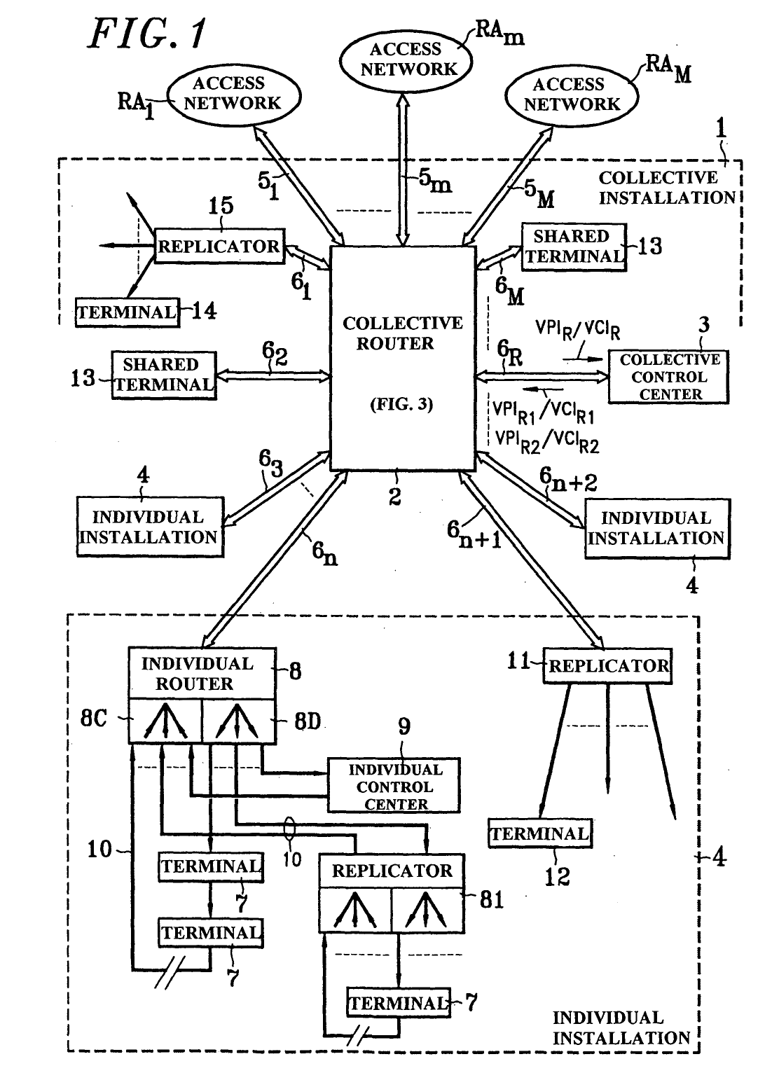

FIG. 1 is a block diagram of a client private collective terminal installation according to the invention;

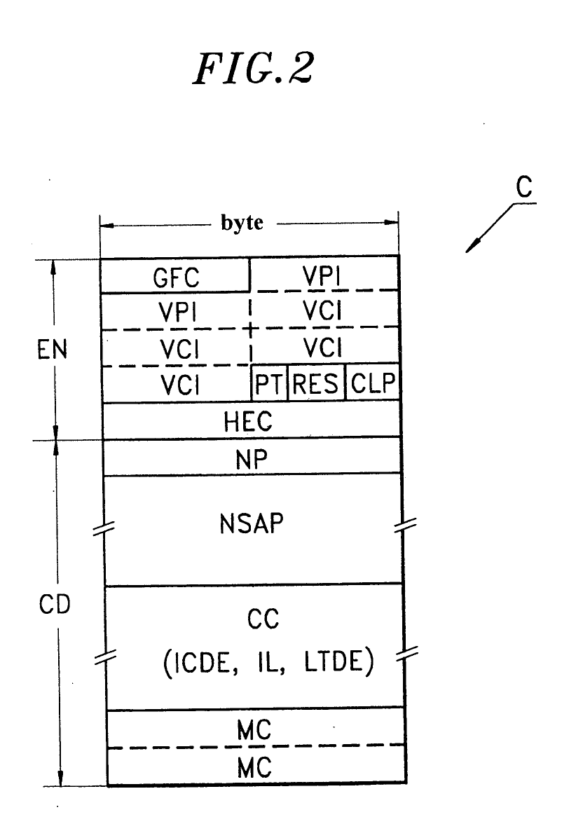

FIG. 2 shows an ATM cell according to the invention;

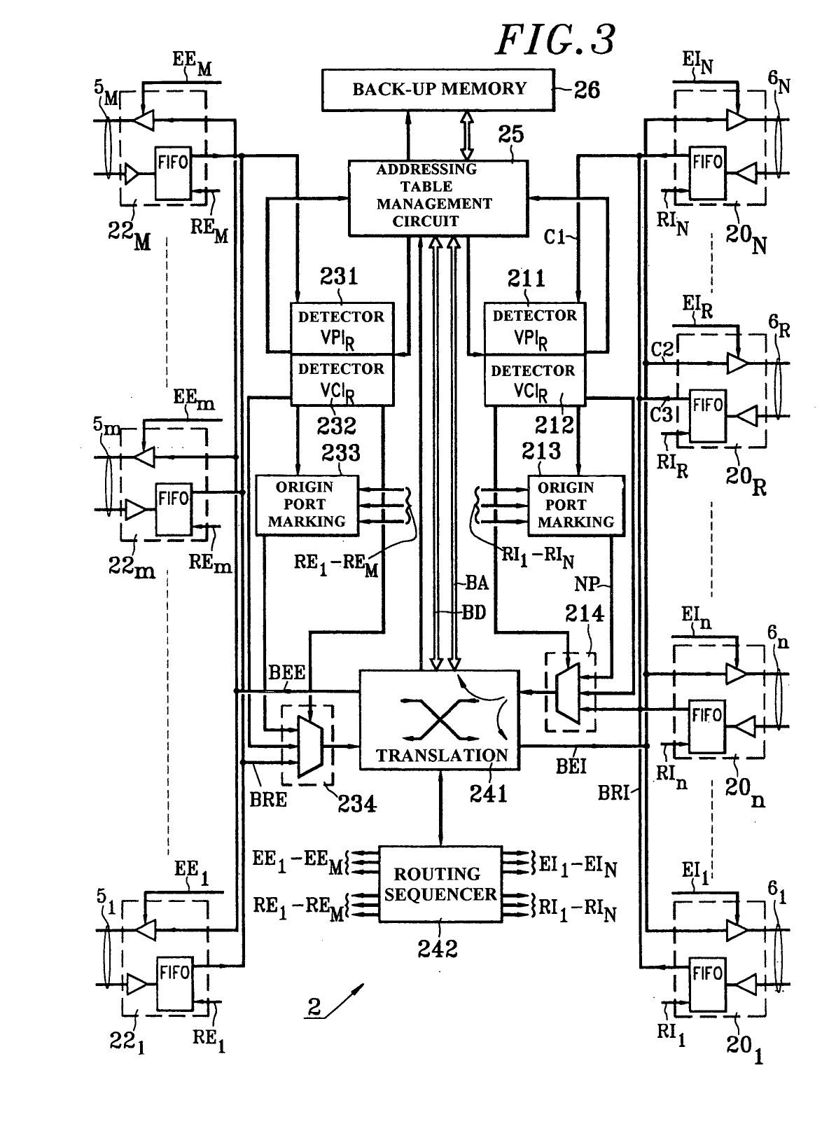

FIG. 3 is a block diagram of a collective router included in the collective terminal installation;

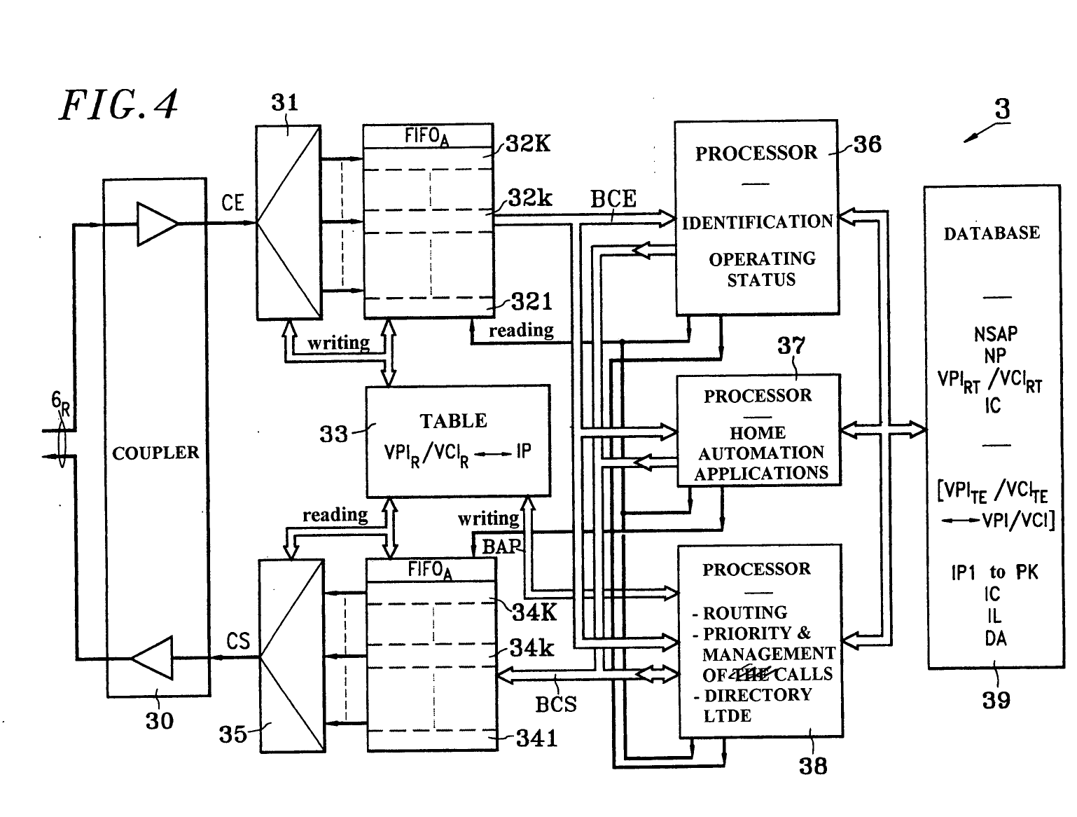

FIG. 4 is a block diagram of a collective control center, included in the collective terminal installation, according to the invention;

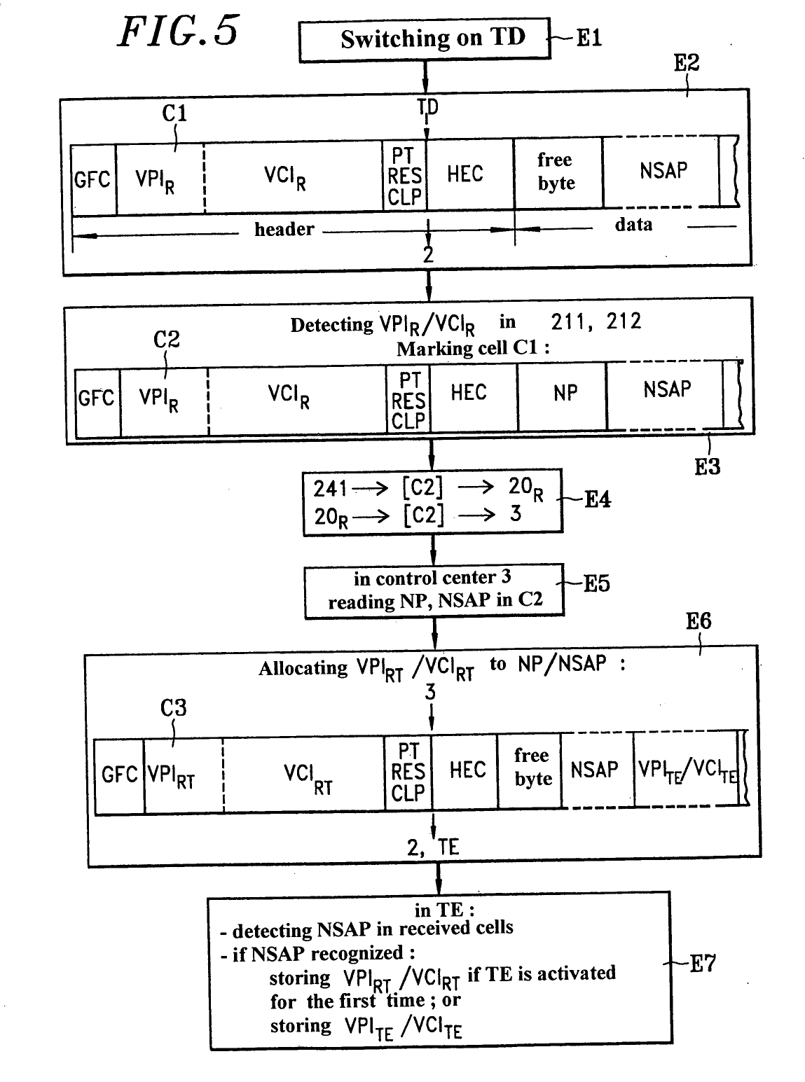

FIG. 5 is an algorithm for dialog between an internal terminal and the collective control center, notably during activation of the internal terminal; and

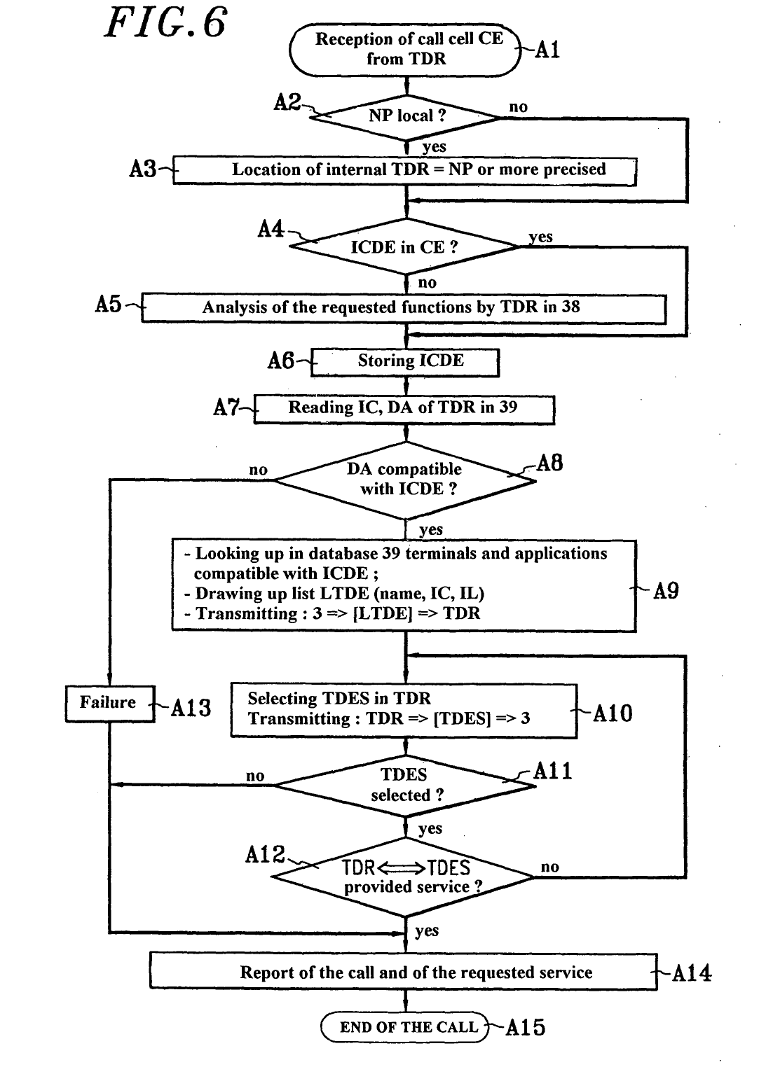

FIG. 6 is an algorithm for processing a function call by a terminal, used essentially in the collective control center.

As shown in FIG. 1, an ATM client private collective terminal installation 1 essentially comprises a collective router 2 associated with a collective control center 3, and plural client private individual terminal installations 4.

The collective router 2 constitutes a collective gateway to the user network interface (UNI) with ATM access provider networks RA₁ to RA_{M}, which are generally telecommunication operators, where M≧1. In practice, the collective router 2 is serviced by at least as many external bidirectional telecommunication lines 5₁ to 5_{M} as there are access provider networks RA₁ to RA_{M}, connected to network digital terminations (NDT), usually of the broadband ISDN type, able to support transmission in accordance with the xDSL technology, to convey streams of ATM network cells. However, as an alternative to this, an external line conveys signals in accordance with a transmission mode other than the asynchronous transfer mode, and the coupler of the collective router servicing the external line provides the adaptation between the asynchronous transfer mode and the external transmission mode.

Using a predetermined addressing table, the collective router 2 routes ATM cells coming from the external telecommunication lines 5₁ to 5_{M} to respective internal telecommunication lines 6₁ to 6_{N} connected in particular to the individual terminal installations 4. The internal lines 6₁ to 6_{N} also convey ATM cells in both transmission directions, but in relation in particular respectively to the individual installations. Accordingly, and reciprocally, the collective router 2 routes ATM cells, in particular from the individual terminal installations 4 via the internal telecommunication lines 6₁ to 6_{N} partly to the external telecommunication lines 5₁ to 5_{M} and partly to telecommunication lines internal to the collective terminal installation 1.

A private individual terminal installation 4 is the responsibility of a client in the collective entity associated with the collective terminal installation 1. For example, an individual terminal installation 4 is that distributed in an apartment in an apartment block in which the collective terminal installation 1 is arranged, or in an office in an office building in which the collective terminal installation is arranged, or in a department of a university or a business occupying a building in a complex of buildings in which the collective terminal installation is arranged. Accordingly, calls within an individual terminal installation are confidential and calls which are addressed to the exterior of the individual installation must obviously not be broadcast to the other installations.

The collective installation instead comprises several cascaded collective routers if the collective installation includes several “collective levels”, for example a building, a floor within the building, and individual installations on that floor; for example, the router 2 shown in FIG. 1 is connected by a few internal lines 6₁ to 6_{N} to respective first level collective routers which are connected to respective second level collective routers.

Externally to the individual installations 4, the collective terminal installation 1 comprises a set of resources for managing the collective installation, such as a collective control center 3 which is connected by a reserved internal telecommunication line 6_{R}. As will emerge hereinafter, the line 6_{R} is reserved for the control center 3 in the sense that the router has tagged the line 6_{R} with a respective address. Accordingly, the line 6_{R} is not dedicated to the control center 3 and can also service terminals, for example by means of a replicator.

The collective control center 3 controls all of the equipment units and installations included in the collective installation 1 and manages services and rights of access thereto, in particular with respect to the external telecommunication lines 5₁ to 5_{M} and shared resources. To be more specific, the collective control center 3 establishes routing set points for any call set-up requests coming either from internal lines when terminals are activated and for outgoing calls therefrom, or from external lines in the case of incoming calls, manages by default all call requests pertaining to calls that have not yet been set up, centralizes and cyclically refreshes a database containing information on the architecture and distribution of the individual installations 4 and shared equipment units, stores the identity and the location of new terminals when they are activated in the collective installation, manages a routing table in the collective router 2 in accordance with established routing set points, and presents local applications.

The collective control center 3 can instead be external to the collective installation 1, for example connected to it by an ATM dedicated line.

FIG. 1 shows in more detail one of the client individual terminal installations 4 connected to the internal line 6ₙ,. It essentially comprises several terminals 7 on the premises of the client and connected to at least one respective internal telecommunication line 6ₙ via a private gateway consisting of an individual router 8, where 1≦n≦N. A terminal 7 can be a microcomputer, a home automation control and/or surveillance device, such as a video camera or a sensor, for example, a local server, a digital telephone, a cable television receiver, etc.

Like the collective router 2 in the collective terminal installation 1, the individual router 8 in the individual terminal installation 4 constitutes a communication node in the installation which is managed by an individual control center 9 and which services the terminals 7 via terminal telecommunication lines 10. The individual terminal installation 4 is a multiterminal client telecommunication installation, for example, as described in French patent application 99-07172 filed Jun. 8, 1999, not yet published.

In the individual installation, the individual router 8 comprises a broadcaster 8D for broadcasting ATM cells received via the respective internal line 6ₙ to the terminals 7 and a collector 8C for collecting ATM cells produced by the terminals 7 and transmitting them to the collective router 2 via the respective internal line 6ₙ. As shown in FIG. 1, the terminals 7 in the installation 4 are on digital transmission local loops constituted by the internal terminal lines 10 between output ports of the broadcaster 8D and input ports of the collector 8C. The individual router 8 also provides an intercommunication facility between terminals 7 in the installation 4 by broadcasting marked intercommunication cells produced by the terminals in the local loops 10 via the broadcaster 8D.

The individual router 8 can instead be a collective router, in order to have access to all the functions of a collective router, and in particular to assist with location of terminals in the individual installation. In this case, the control center 9 includes functions analogous to those of the control center 3 with respect to the router 8 and to the terminals 7 of the individual installation 4.

Each terminal 7 is connected to a local terminal loop 10 via an ATM network interface or via an adapter if the terminal is a conventional telecommunication device with no network interface. The interface or the adapter receives ATM cells broadcast by the broadcaster 8D, inserts ATM cells produced by the terminal into the local loop, and repeats cells to be forwarded to other terminals in the local loop to the collector 8C. Couplers of send/receive ports in the broadcasters and collectors of the individual routers 8, as well as the terminals and their interfaces and adapters, are inventoried in a database of the individual control center 9 centralizing all information on the architecture of the individual terminal installation 4. As a general rule, information relating at least to the identification of the terminals 7 is also held in the collective control center 3.

In a variant, the individual control center 9 is external to the client premises of the installation 4, in the same way as the collective control center 3, and connected by a dedicated ATM line, for example.

An individual terminal installation 4 can be connected to the collective router by more than one internal line. For example, a second internal telecommunication line 6ₙ₊₁ connects the collective router 2 to a port replicator 11 which is included in the installation 4 and which services terminals 12 by broadcasting collective services. The replicator 11 has a structure analogous to that of the individual router 8, in other words it comprises an ATM cell broadcaster and an ATM cell collector, and provides no cell routing function and thus no intercommunication facility between the terminals 12, which are not able to communicate with each other. The replicator 11 broadcasts only information from each of its output ports. To maintain the confidentiality of information broadcast to the terminals 12, the internal telecommunication line 6ₙ₊₁ to which the replicator 11 is connected is unidirectional, and the replicator 11 does not forward any ATM cell to the collective router 2.

Replicators 11 can be connected in cascade, including on the far side of an individual router 8, like the bidirectional replicator 81 shown in FIG. 1.

As also shown in FIG. 1, the client private collective terminal installation 1 can also include resources shared between the clients who own the individual installations 4. These shared resources include shared terminals 13, some of which can each be connected by an internal telecommunication line 6₂, 6_{N}, and others of which can be connected in cascade by a telecommunication line forming a loop, like an internal loop 10 in an individual installation 4. A shared terminal 13 constitutes a “fixed” terminal providing services to all clients in the collective installation who are authorized by the collective control center 3 directly or from a terminal 7 of an individual installation 4 or from a roaming terminal of an authorized visitor client who is present temporarily in the installation 1. Like the terminals 7, a terminal 13 contains an adapter for receiving, inserting and repeating ATM cells if it does not already have a network interface compatible with the transmission format used in the collective installation 1.

A shared terminal 13 is a printer, a facsimile machine, a building entryphone, a washing machine or a service application server, for example.

Other shared terminals 14 can be connected to the collective router 2 via a replicator 15, in an analogous manner to the replicator 11 and the terminals 12 in an individual installation 4. The terminals 14 are TV receivers, for example, or surveillance monitors of the collective entity associated with the installation 1.

A telecommunication line 6ₙ internal to the collective installation 1 or a telecommunication line 10 internal to an individual installation 4 can comprise a pair of metal wires or a monomode, multimode or plastics material optical fiber, or, at least in part, a radio channel. For example, the bit rate in a telecommunication line 6ₙ, 10 is 32 Mbit/s and corresponds to a predetermined bit rate of (⅘)32=25.6 Mbit/s on the far side of a send/receive coupler in the collective router 2 or the individual router 8, or a replicator 11, 15 after a binary 5B-to-4B receive transcoding and a binary 4B-to-5B send transcoding. In another variant, the in-line bit rate can be higher, for example 155.52 Mbit/s, the transcoding being of the 8B-to-10B type, and the cells delimited by 27-cells frames.

Given that some ATM cell fields are processed in the collective router 2 and the collective control center 3 according to the invention, the format of an ATM cell is described briefly hereinafter with reference to FIG. 2. An ATM cell comprises a header EN including five bytes and a data field CD constituting a payload with a constant size of 48 bytes.

The first field of the header relates to generic flow control (GFC) and has four bits.

The next six half-bytes of the cell header are occupied by a routing address field VPI/VCI containing a virtual path identifier (VPI) on one byte and a virtual channel identifier (VCI) on two bytes. For example, in the collective installation 1, a virtual path comprises an internal telecommunication line 6ₙ and a virtual channel on this line is allocated by the collective control center 3 to bidirectional communication with a terminal serviced by that line as will be seen below. To give another example, a VPI designates a set of internal telecommunication lines to which VCI are allocated dynamically by the control center 3. To give a further example, a single predetermined VPI is allocated to the collective installation 1, and the control center 3 manages the allocation of VCI identifiers of the virtual channels of the path designated by the predetermined VPI identifier to the lines 6₁ to 6_{N} internal to the collective installation.

In other variants, the VPI and VCI identifiers relating to virtual channels internal to the installation 1 occupy only a portion of the address field VPI/VCI comprising three bytes.

The second half-byte of the fourth byte of the header comprises three fields PT, RES and CLP that are not relevant to the invention.

The fifth and final byte of the header of an ATM cell constitutes a header error control field HEC. Before sending the cell, the content of the field HEC is computed as a function of the first four bytes of the cell by a predetermined algorithm. After the cell is received, the field HEC is used to correct single errors in the header of the cell as received and to reject the cell if more than one error is detected in the cell or if errors are detected in a predetermined number of consecutive cells on the same logical channel VPI/VCI. If it is correct, the field HEC also serves as a cell delimiter.

Hereinafter, it will be assumed that the field HEC in an ATM cell passing through the collective router 2 or the collective control center 3 is recomputed each time that the routing address field VPI/VCI in particular is modified, replaced or translated.

The data field CD of a cell in the installation is used in accordance with the invention to route some parameters for initializing a terminal or a call, such as routing addresses, a port number NP, a terminal identifier NSAP and a control field CC which can contain a class indicator ICDE or keywords expressing a request from terminals having a common function, a location indicator IL, a list of terminals LTDE, the designation of a selected called terminal, or a request, a command or an acknowledgement, and finally a check word (checksum) MC for checking the integrity of the data field.

Referring to FIG. 3, the collective router 2 essentially comprises send/receive couplers 20₁ to 20_{N} and means for detecting predetermined routing addresses 211-214 in relation to telecommunication lines 6₁ to 6_{N} internal to the collective installation 1, send/receive couplers 22₁ to 22_{N}, and means for detecting predetermined routing addresses 231-234 in relation to telecommunication lines 5₁ to 5_{M} external to the collective installation, together with logical channel switching means 241-242 and addressing means 25-26 are arranged at the core of the collective router 2, between the aforementioned entities 20₁-20_{N}, 211-214 and 22₁-22_{M}, 231-234, for routing ATM cells between internal lines and external lines and between different internal lines, in accordance with a routing table managed by the collective control center 3.

Each send/receive coupler 20ₙ, 22ₘ where 1≦n≦N and 1≦m≦M, comprises a send coupler and a receive coupler. The send coupler forwards ATM cells from a send bus BEI, BEE internal to the collective router 2 to an output port connected to the respective internal transmission line 6ₙ or to the respective external transmission line 5ₘ. During this forwarding, the send coupler serializes each cell byte, frames the cells, where applicable, and scrambles and transcodes the stream of cells to be sent. Reciprocally, the receive coupler forwards cells from the respective internal transmission line 6ₙ or from the respective external transmission line 5ₘ to a receive bus BRI, BRE internal to the collective router. In particular, the receive coupler transcodes and descrambles the stream of cells received, removes the frame configuration therefrom, where applicable, and converts each byte to parallel form.

Reading and writing ATM cells byte by byte are controlled cyclically by send and receive control signals produced by a routing sequencer 242 in the cell switching means. The sequencer is closely associated with the timebase (not shown) of the collective router.

The cells routed on the internal send bus BEI are read cyclically in the send couplers 20₁ to 20_{N} under the control of send control signals EI₁ to EI_{N}. The cells received by the receive couplers 20₁ to 20_{N} are written cyclically onto the internal receive bus BRI under the control of receive control signals RI₁ to RI_{N}. Similarly, externally to the collective installation 1, the send couplers 22₁ to 22_{M} read cells cyclically on the external send bus BEE under the control of send control signals EE₁ to EE_{M}, and cells received by the receive couplers 22₁ to 22_{M} are written onto the external receive bus BRE under the control of receive control signals RE₁ to RE_{M}.

FIFO buffers in the receive couplers, at the input of the receive buses BRI and BRE, absorb any traffic congestion of ATM cell incoming into the collective router 2 and coming from the interior and the exterior of the collective installation.

Each predetermined routing address detecting means on the collective installation side and on the access network side essentially comprises a control center address detector 211,231, a reserved routing address detector 212,232, an origin port marking circuit 213,233, and a multiplexer 214,234.

The control center address detector 211,231 holds in memory an address of the collective control center 3 which is assumed, for clarity, to comprise a virtual path identifier VPI_{R} allocated to the internal telecommunication line 6_{R} servicing the collective control center 3 and thus identifying the port of the collective router materialized by the coupler 20_{R}. The address VPI_{R} is originally written into memory in the detector 211, 231 of the router, or is transmitted to the router 2 by the control center 3 in order for it to be written into the detector 211,231 during a router initialization phase.

As already stated, any internal line 6₁ to 6_{N} connects the collective control center 3 to the collective router 2, and consequently any routing address VPI_{R}/VCI_{R} can obviously be allocated to the control center 3. Allocating the address VPI_{R} to the collective control center 3 in the detector 211, 231 beforehand, and more particularly the prior allocation of several routing addresses VPI_{R}/VCI_{R} reserved for the control center, in particular for differentiating qualities of services, avoids subsequent attempts to allocate logical channels intended for calls to the control center to an individual terminal installation 4, or a shared terminal 13, or a replicator 15, for example.

The reserved routing address detector 212, 232 holds in memory addresses VCI_{R} of virtual channels reserved for the collective control center 3 and forming reserved routing addresses VPI_{R}/VCI_{R} with the identifier of the control center 3 in cells forwarded by the router 2 to the control center 3 via the reserved line 6_{R}. The routing addresses VPI_{R}/VCI_{R} reserved for the control center are initially introduced into the memory of each terminal 7, 13 in the collective installation 1 while configuring it and prior to activating it. Thus the detectors 211-212, 231-232 detect on the receive bus BRI, BRE routing addresses VPI_{R}/VCI_{R} included in the address fields of cells transmitted by the terminals 7, 13, for example on switching on a terminal, or at the time of a call set-up request from a terminal, or for calls for the control center from an access network, for example for communication with an internal terminal, or for downloading a particular application into the control center.

Several routing addresses VPI_{R}/VCI_{R} are preferably reserved for the control center in order to assign them to respective actions relating to the control center, to the terminals, and to applications.

Accordingly, the detectors 211-212, 231-232 scan the respective bus BRI, BRE to detect the routing address fields in the received ATM cells and to compare them to the reserved routing addresses VPI_{R}/VCI_{R} stored in memory, and thus detect any routing address in a received cell that is different from the reserved addresses stored in memory. In this latter case, the unknown routing address in the received cell is sent to the addressing means 25-26 in order to check if it is in an addressing table. If not, the addressing means controls the detectors 211-212, 231-232 to replace the unknown routing address with a predetermined reserved address VPI_{R}/VCI_{R} so that the corresponding cell is transmitted to the collective control center 3.

The origin port marking circuit 213,233 identifies the origin port NP, i.e. the receive coupler 20₁ to 20_{N}, 22₁ to 22_{M} through which is received a cell containing either a reserved routing address VPI_{R}/VCI_{R} detected or a reserved routing address VPI_{R}/VCI_{R} after an unknown routing address is detected. The marking circuit 213 or 233 introduces the port number NP=n or NP=m of the corresponding receive coupler 20ₙ or 22ₘ into the first byte of the data field of the received cell, for example. Origin port marking is used so that the control center can send a response cell back to the origin port via which a terminal has transmitted a cell with a reserved address.

When there are several routers 2 in cascade, for example on a floor of a building, in an apartment, and in a room, each router marks the cell with a port number corresponding to the internal line servicing the floor, the apartment or the room, with the result that the router connected to the collective control center 3 sends cells marked with three port numbers.

No marking is effected for cells sent by the collective control center 3 and coming from the associated receive coupler 20_{R}.

Just like the origin port marking circuit 213, 233, the multiplexer 214, 234 is controlled by the routing address detectors 211-212, 231-232 to insert the origin port number, as the sixth byte of a cell at the start of the data field of this cell, into each cell to be marked. Where necessary, the detectors 211-212, 231-232 control the multiplexer 214, 234 to substitute a reserved routing address for an unknown routing address, under the control of the addressing means 25-26.

The logical channel switching means comprises an interconnection matrix 241 associated with a routing sequencer 242. The interconnection matrix 241 mainly translates routing addresses VPI/VCI in the ATM cells received via the receive buses BRI and BRE into translated routing addresses before sending the cells on the respective buses BEI and BEE. According to the translated address, a cell received via the bus BRI internal to the collective installation 1 is routed either to the send bus BEI, which is also on the collective installation side, if two terminals 7, 13 are communicating or if a terminal and the collective control center 3 are communicating, or to the send bus BEE, which is on the side of the access networks RA₁ to RA_{M} in the case of a call between a terminal and the exterior of the installation.

The routing sequencer 242 produces respective receive control signals RI₁ to RI_{N} and RE₁ to RE_{M} for sequentially opening the receive couplers 20₁ to 20_{N} and 22₁ to 22_{M} and produces respective send control signals EI₁ to EI_{N} and EE₁ to EE_{M} for sequentially opening the send couplers as a function of the routing of the cells with the translated routing addresses. The receive control signals RI₁ to RI_{N}, RE₁ to RE_{M} are also applied to the respective marking circuit 213, 233 which marks the origin port, i.e. the origin receive coupler through which the received cell to be marked has passed.

The routing addresses VPI/VCI are translated in the interconnection matrix 241 as a function of the correspondence between routing addresses stored in memory in an addressing table management circuit 25 essentially constituting the addressing means.

The addressing table generally matches a routing address VPI/VCI in a cell transmitted by a terminal or the like of the collective installation 1 to a routing address VPI/VCI identifying a destination logical channel on the side of the access networks RA₁ to RA_{M}, and conversely for the opposite transmission direction, for a call between the interior and the exterior of the collective installation.

The correspondence of routing addresses is not relevant to the addresses reserved for the control center and relates to permanent and temporary connections set up by the collective control center 3 at the call set-up time. A pair of addresses allocated to a permanent or temporary connection bidirectionally associates virtual channels in two internal transmission lines 6₁ to 6_{N}, or a virtual channel in an external access network line 5₁ to 5_{N} and a virtual channel in an internal telecommunication line 6₁ to 6_{N}.

A permanent connection is needed for some applications, in an analogous manner to leased telecommunication lines. For example, a permanent connection is used to connect a terminal consisting of a permanent video camera for detecting break-ins monitored remotely by a server on one of the access networks RA₁ to RA_{M}.

A permanent connection between the collective control center 3 and each access network RAₘ is essential so that the collective installation and thus any terminal in it can be called.

A temporary connection conventionally relates to a telephone or data call during a finite period involving at least one terminal or the like of the installation 1. The collective control center 3 allocates a routing address VPI/VCI, or to be more precise a logical channel, to the terminal as a function of the logical channel resources available in the installation 1 at the time of a call set-up request described later with reference to FIG. 3.

A temporary connection is time-shared by several terminals. The corresponding pair of routing addresses is allocated to any of these terminals between seizing and release of the virtual channel, which is analogous to seizing and release of the line in conventional telephony.

A corresponding pair of routing address, i.e. of logical channels, is written permanently or temporarily and dynamically into the routing table programmed by the collective control center 3 as and when connection set-up requests are submitted, and preferably in a reserved routing address priority order, as already mentioned. For each permanent or temporary connection set up, routing addresses in the cells received via the interconnection matrix 241 are translated automatically by using the routing address of the received cell as an address for reading the routing table, in order to read therein the corresponding translated routing address to be introduced into the header of the cell, which can then be sent. The cells are routed from one port to another without passing through the collective control center 3.

Thus the addressing table circumvents constraints on addressing access networks RA₁ to RA_{M} external to the collective installation 1. The collective installation manager can, in the collective control center 3, allocate routing addresses VPI/VCI relating to logical channels internal to the installation, at least during activation of the installation, without worrying about constraints on addressing external access networks, which may differ fundamentally, as a function of the access provider. Translating routing addresses in the interconnection matrix 241 in accordance with the addressing table in the management circuit 25 programmed by the control center 3 thus ensures that addresses within the collective installation are independent of addresses external to it.

The addressing means further includes a non-volatile memory 26 for backing up the addressing table, i.e. the correspondences between the routing addresses of received cells and the routing addresses of sent cells. The addressing table is therefore backed up in the memory 26 in the event of a power failure at the collective router. The back-up memory 26 is updated after introducing a new address into or changing an existing address in the addressing table 25 between cell processing operations, at times when there is no call on the addressing table memory internal to the circuit 25. The back-up memory 26 also stores in memory the virtual path identifier VPI_{R} corresponding to the line 6_{R} connected to the collective control center 3 and the list of virtual channel addresses VCI_{R} reserved for communication with the control center.

Briefly, three main types of routing address VPI/VCI are provided in cells routed in the collective terminal installation 1.

A first type of routing address relates to “standard” ATM cells for a permanent or temporary call authorized by the control center 3 between a terminal 7, 13 and a terminal external to the installation, i.e. between a virtual channel on one of the internal telecommunication lines 6₁ to 6_{N} and a virtual channel on one of the external telecommunication lines 5₁ to 5_{M} or on one of the internal lines in accordance with corresponding routing addresses stored in memory in the addressing table 25, i.e. in accordance with non-reserved routing addresses known from the table.

A second type of routing address relates to ATM cells for dialog with the control center 3 and each containing a reserved address VPI_{R}/VCI_{R}.

A third type of routing address relates to ATM cells intended for configuring the routing table 25 and sent by the control center 3, as will be seen below.

Referring now to FIG. 4, the collective control center 3 essentially comprises a send/receive coupler 30 connected to the reserved line 6_{R}, incoming cell management means 31-32-33, outgoing cell management means 33-34-35, and multiprocessor means 36-37-38 for managing the terminals, the routing of calls with the terminals and home automation applications. The control center 3 takes the form of a microcomputer with an ATM network card connected to a printer, for example.

The send/receive coupler 30 in the control center 3 has functions analogous to the couplers 20₁ to 20_{N} and 22₁ to 22_{M} of the collective router 2. In particular, it synchronizes a timebase in the control center as a function of a clock recovered from the stream of incoming cells CE sent by the router 2 via the reserved line 6_{R}.

The two cell management means share a mapping table memory 33 which matches priority indicators IP of reserved cells and routing addresses VPI_{R}/VCI_{R} reserved for downlink and uplink calls with the control center and respectively contained in the routing address field of incoming cells CE received by the coupler 30 and of outgoing cells CS to be sent by the coupler 30. For example, the priority indicators are organized in an increasing priority order IP1 to IPK and designate K incoming cell queues 321 to 32K and K outgoing cell queues 341 to 34K serving as first and second buffers.

In the incoming cell management means, a cell decoder-switcher 31 compares the routing address fields of the incoming cells received by the coupler 30 to the routing addresses VPI_{R}/VCI_{R} reserved for uplink calls to the control center 3 and read in the table memory 33. An incoming cell is then written into the queue 32k addressed by the priority indicator IPk read in the memory 33 in correspondence with the reserved routing address contained in the incoming cell and found in the table memory 33, where 1≦k≦K. The incoming cells are read in the first queues 321 to 32K, starting by reading and emptying the queues addressed by the highest priority indicators in order to process them in that order in the multiprocessor means via a bus BCE.

Thus the multiprocessor means 36-37-38 process the incoming cells CE, by starting with those associated with the highest priority indicators, in order to produce outgoing cells CS to be sent also as a function of priority indicators.

Conversely, the processor 38 compares the routing address fields of the outgoing cells CS produced by the multiprocessor means 36-37-38 via a data bus BCS to the reserved routing addresses read in the table memory 33. Under the control of a priority addressing bus BAP connected to the processor 38, each outgoing cell is stored in memory in the queue 34k as a function of the priority indicator IPk read in the memory 33 in correspondence with the reserved routing address VPI_{R}/VCI_{R} contained in the routing address field of the outgoing cell. A send multiplexer 35 between the outputs of the second queues 341 to 34K and the input of the send coupler 30 sends the outgoing cells CS in decreasing priority indicator order, starting by reading and emptying the second queues 341 to 34K containing at least one outgoing cell and addressed by the highest priority indicators.

In a variant, the number of priority indicators for the reserved routing addresses in the incoming cells can differ from the number of priority indicators for the reserved routing addresses in the outgoing cells, since the priority nature and the number of different pollings and responses from the control center to the terminals is obviously not necessarily identical to the priority nature and the number of different responses and pollings from the terminals to the control center.

For example, a call request from a conventional terminal to an access network has priority over a periodic operating status message transmitted by a home automation terminal but does not have priority over an alarm message transmitted by a fire detector.

To conform to an ATM quality of service, the priority order depends on actions requested of the control center in the incoming cells CE and actions requested of the terminals in the outgoing cells CS, including predetermined applications and/or predetermined phases of applications.

The priority order for processing cells in the control center 3 as a function of the reserved addresses VPI_{R}/VCI_{R} is independent of the cell loss priority (CLP) bit in the header of an ATM cell.

The multiprocessor means in the collective control center essentially comprises three processors 36, 37 and 38 which can be combined in one microprocessor. The processors jointly manage a database 39 relating to various parameters of the terminals processed by the processors, such as addresses, identifiers and indicators.

The processor 36 manages the identification and the operating status of each terminal declared to the control center, generally designated terminal TE for any terminal 7, 13 or like terminal means 9, 11, 15 in the collective installation. In the database 39, each terminal TE that has been activated in the installation, as will seen below, is identified and tagged, in particular by a respective network service access point identifier NSAP, the port number NP of the receive coupler 20ₙ, 20ₘ of the collective router 2 through which the incoming cells CE sent by the terminal pass, and is addressed to parameters and routing addresses managed principally by the third processor 38.

The single identifier NSAP of the terminal TE is included in the data field (payload) CD of an incoming cell. The terminal identifier NSAP typically extends over twenty bytes following the first byte or first bytes of the data field occupied by the port number NP.

The identifiers NSAP designate respectively terminals in an ATM network. The identifier NSAP typically begins with three bytes indicating the format of the identifier and the authority by which that format was defined, followed by ten bytes comprising a “sub-network” address designating the collective installation 1 as a function of the ATM addressing scheme of the network operator, six bytes identifying the terminal itself, and often fixed once and for all in the ATM adapter or interface that the terminal contains, and a final byte for addressing a software task in the terminal identified by the preceding 19 bytes.

The six bytes identifying the terminal itself contain an identifier of the manufacturer of the terminal, an identifier IT of the terminal type, and a serial number, in an analogous manner to a medium access control (MAC) address.

The processor 36 also manages class indicators IC which are entered by the collective control center manager to be written into the database 39 after the first activation of terminals internal to the collective installation. A class indicator IC defines, although in a less precise manner than the type indicator IT in the MAC address, one or more predetermined functions that the terminal, when called, can offer in response to polling by calling terminals. However, instead of this, it is considered hereinafter that the type indicator IT can replace or complement the class indicator IC to define the functions of a terminal.

For example, a multifunction terminal offering facsimile, printing and scanning is classed by the manager with a class indicator corresponding to only one or two of the above three functions if at least the scanner function is accessible only subject to specific access rights. Other class indicators indicate, for example, heating, lighting and surveillance functions, domestic services, consultation or database services, etc. Several class indicators can be associated with the same terminal.

The predetermined functions requested, including applications or services, can be dedicated functions provided by the collective control center itself, notably by means of the processor 37 or 38. For example, drivers supplied by the manufacturer of each internal terminal are implemented automatically in a dedicated RAM portion of the control center 3 when the terminal is activated, in association with the identifier NSAP of the terminal. These drivers can relate to remote controls of various types of telecommunication terminal, such as telephones, videophones, modems, etc., and modes of graphical representation, a name and/or a picture, of the terminal in order to symbolize the terminal in a displayable list of requested services.

The operating status of the terminal TE is stored in memory in the database 39 by the processor 36 on reception of an incoming cell sent by the terminal TE and containing a routing address reserved for a first activation, and thereafter reception of incoming cells sent by the terminal TE and reserved for acknowledging outgoing cells reserved for periodic polling of the terminal TE sent by the processor 36. When the terminal TE is activated for the first time, the processor 36 matches an available routing address VPI_{RT}/VCI_{RT} and the port number NP of the terminal TE, in order to include it in any outgoing cell CS from the control center addressed to the terminal. If in response to a polling cell the processor 36 no longer receives any acknowledgement cell from the terminal TE, after the latter has been shut down for a relatively long time period, the processor 36 makes available in the database 39 the routing address VPI_{RT}/VCI_{RT} for a downlink call from the control center to another terminal. The terminal TE will follow the first activation procedure when it is next switched on at the end of the relatively long time period.

The second processor 37 manages local home automation applications in the collective installation 1. The processor 37 enables the control center manager to select, manage and control home automation terminals in the collective installation. A home automation terminal can be an entryphone, a surveillance video camera, an intruder detector, a smoke detector, a lamp, a radiator or a boiler, a roller shutter, etc. The screen of the collective control center 3 displays a graphical representation of the terminal, such as an icon or a symbol, as well as shapes, keys and/or graphical items. The manager controls functions of the home automation terminal via the processor 37, such as pointing a camera, adjusting a radiator thermostat, the intensity of a lamp, etc. The processor 37 then produces outgoing cells CS addressed to the home automation terminal and having data fields containing commands. The processor 37 also processes command acknowledgement cells incoming to the control center.

The third processor 38 manages internal and external calls, i.e. all calls from the internal terminals and external calls coming from the access networks RA₁ to RA_{M}, routing addresses, and the priority indicators IP1 to IPK, as well as a directory of the terminals of the collective installation 1.

It is mandatory for an outgoing or incoming call to be set up via the collective control center 3.

If the call is an outgoing call triggered by receiving an outgoing cell CS transmitted by a requesting internal terminal TE and having a routing field containing a routing address reserved for a call request, the processor 38 authenticates the calling terminal by means of a predetermined authentication algorithm. Depending on access rights DA allocated beforehand to the calling terminal TE by the manager of the control center 3 and according to the availability of internal logical channels, the processor 38 allocates a routing address VPI_{TE}/VCI_{TE} designating an internal logical channel between the router 2 and the internal terminal, and matches it and another routing address VPI/VCI designating an internal or external logical channel from the router 2 to the remote internal or external called terminal. A routing address VPI_{TE}/VCI_{TE} is allocated in an analogous manner to the terminal TE which becomes the called terminal in the case of an incoming call.

The processor 38 therefore manages a table of pairs of routing addresses, which is analogous to the routing table 25 of the collective router, and thus updates the routing table 25 after each call request for the router 2 to execute the routing set points produced in this way by the control center 3 to route conventional telephone or data calls between two internal terminals or between an internal terminal and an external terminal.

This latter correspondence between two routing addresses is transcribed into the routing table of the collective router 2 by means of routing table configuration cells produced by the processor 36, outgoing from the control center 3 and processed by the routing table management circuit 25. The addressing field in the header of an outgoing configuration cell contains either a first reserved address VPI_{R1}/VCI_{R1} to command the introduction of a new internal/external or internal/internal routing address pair into the addressing table of the circuit 25 or a second reserved address VPI_{R2}/VCI_{R2} for modifying an internal routing address in an internal/external or internal/internal routing address pair.

The processor 38 also manages the table memory matching reserved routing addresses VPI_{R}/VCI_{R} and priority indicators IP1 to IPK via the bus BAP. The correspondences in the table memory 33 are initially programmed and updated via the processor 38 by the manager of the control center 3, as and when the installation 1 evolves. The processor 38 manages its own parallel multitasking operations and those of the other two processors 36 and 37 in order to execute priority tasks first, to the detriment of intentional interruptions of lower priority tasks already being executed, according to the priority indicators IP1 to IPK.

The processor 38 also manages a directory of terminals which is dependent on the access rights DA, class indicators IC, and location indicators IL of the terminals.

The access rights DA associated with a calling terminal TDR represent total or partial access to one or more predetermined functions of a called terminal TDE, or to an application in the called terminal, such as a home automation terminal or a shared terminal, or to a service dispensed by an access network. The access rights DA of the calling terminal TDR are allocated and updated by the manager of the control center 3 and stored in memory in the database 39 via the processor 38 and in association with the identifier NSAP of the calling terminal, after the latter has declared itself to the control center when it is activated for the first time. The processor 38 compares the access rights DA with the class indicators IC stored in memory in the database 39 in response to reserved incoming cells CE sent by the calling terminal so as to authorize access of the calling terminal only to terminals or applications offering class indicators compatible with the access rights.

For example, the access rights of a calling terminal TDR authorize access in read and/or write mode and/or for predetermined modifications to terminals corresponding to a few selected types of called home automation or shared terminals. If the class indicator IC of the called terminals contained in the data field of an incoming cell CE sent by the calling terminal defines a called terminal type that is inaccessible, given the access rights DA of the calling terminal, the processor 38 prohibits access of the calling terminal to the called terminals of class IC.

If the calling terminal is a “roaming visitor” terminal, it declares itself to the processor 36 in the same way as a fixed terminal of the installation. The manager of the control center 3 appends dedicated access rights to the roaming visitor terminal in order for the processor 38 to offer it specific resources of the collective installation and to identify terminals called by the roaming visitor terminal. This prevents piracy and where applicable enables services to be billed to the user of the roaming visitor terminal.

In a first variant, the processor 38 automatically allocates a location indicator IL to a terminal in an individual installation 4 or to a shared terminal, for example, only in correspondence with the port number NP of the collective router 2 designating the internal line 6₁ to 6_{N} which services the terminal.

In a second variant, and like the access rights DA, the location indicators IL respectively associated with the internal terminals are entered by the manager of the collective control center and stored in memory in the database 39 via the processor 38 after respective activations of the internal terminals in the collective installation. If a terminal is roaming in the installation, the associated location indicator is updated after each new activation. A location indicator IL indicates relatively precisely the location of the associated terminal in the collective installation 1 or in an individual installation 4, for example in a subdivision of the latter, such as a room in the case of an apartment, a floor in the case of a building, or even at a precise location within the room.

In a third variant, a location indicator IL of a terminal is entered by the user of the terminal and included in the control field CC of the data field CD of an incoming cell CE having a routing address reserved at the time of activating the terminal in the collective installation. The processor 38 then extracts the location indicator IL from the cell incoming via the bus BCE in order to store it in memory in association with the identifier NSAP of the terminal, which is also extracted from the incoming cell.

In practice, a response generated by the processor 38 to an incoming cell searching for called terminals TDE and sent by a calling terminal TDR contains in one or more outgoing cells the name(s) of functions of the called terminals that have been found and the name(s) of the places where they are installed, respectively in accordance with the indicators IC and IL of the called terminals. The response also contains an “authorized” or “prohibited” message associated with the called terminals as a function of the correspondence of the access rights DA of the calling terminal. The processor 38 with the database 39 is thus equivalent to a search engine and transmits displayable and/or vocal responses indicating the search results. For example, a client can consult on a terminal a list of all shared printers of the collective installation or a list of DECT telephone base stations for DECT cordless telephones or DECT/GSM dual mode mobile telephones, in order to go to the nearest one, as a function of the location indicators.

In the case of a call to a named called terminal TDE by an incoming cell CE sent by the calling terminal TDR, the processor 38 transmits response outgoing cells CS containing either a list identifying terminals in the same class as the called terminal, or in a variant the identifier of the terminal in the same class which is nearest the calling terminal, if the processor 39 does not find the identifier of the terminal specifically requested in the database 39.

Referring to FIG. 5, a dialog between the collective control center 3 and any terminal 7, 13 or like terminal means 9, 11, 15, hereinafter called as a terminal TE, in the collective terminal installation 1 comprises the following steps El to E7 when the terminal TE is activated for the first time.

After the terminal TE is switched on in step E1, and after synchronization has been recovered at the level of the line internal to the installation to which the terminal TE is connected, the terminal TE sends the collective router 2 an ATM recognition cell C1 (step E2). The routing address field of the cell C1 contains a routing address VPI_{R}/VCI_{R} reserved exclusively for activating any terminal of the collective installation 1. The data field CD of the cell C1 contains the unique identifier NSAP of the terminal TE.

After the cell C1 sent by the terminal is received in the corresponding coupler 20₁ to 20_{N} of the collective router 2 in the next step E3, the addressing field in the header of the cell C1 on the receive bus BRI is read by the detectors 211 and 212 which recognize therein the identifier VPI_{R} of the virtual path 6_{R} allocated to the control center 3 and the identifier VCI_{R} of the virtual channel reserved for activating a terminal. The detectors 211 and 212 consequently control the marking circuit 213 to mark the cell C1 by introducing into the first byte of the data field the port number NP corresponding to the receive coupler 20₁ to 20_{N} through which the cell was received. The receive coupler is identified as a function of the respective receive control signal RI₁ to RI_{N} produced by the sequencer 242. Consequently, at the output of the multiplexer 214, the first byte of the data field of the marked received cell C2 is occupied by the number NP of the corresponding receive port.

In step E4, the addressing table 25, on recognizing that the marked cell C2 contains an address reserved for the control center, routes the cell C2 through the interconnection matrix 241, which does not effect any translation, from the output of the multiplexer 214 to the internal send bus BEI in the direction of the send coupler 20_{R} connected to the collective control center 3 and opened by the sequencer 242.

In step E5, the marked cell C2 is processed by the processor 36 of the control center 3, which reads therein the terminal identifier NSAP and extracts therefrom the port number NP in order to associate them in the database 39, which enables the processor 38 to locate the terminals in the installation and thus to indicate a list of terminals in a class requested by a user of the collective installation.

In step E6, the processor 36 allocates to the terminal TE, in other words to the pair NSAP-NP, an available routing address VPI_{RT}/VCI_{RT} which contains the virtual path identifier VPI_{RT} corresponding to the port number NP, in order to send a cell back to the corresponding send coupler of the collective router. In response to the marked received cell C2, the processor 36 transmits an unmarked ATM acknowledgement outgoing cell C3 having a header containing the routing address VPI_{RT}/VCI_{RT} allocated to the terminal TE and a data field CD containing, starting from the second byte, the terminal identifier NSAP. The cell C3 being transmitted by the control center 3 via the coupler 20_{R} is not marked in the router 2 and passes through the bus BRI, the multiplexer 214, the interconnection matrix 241 and the send bus BEI, for forwarding to the send coupler 20₁ to 20_{N} of the collective router corresponding, among others, to the routing address VCI_{RT}/VPI_{RT} previously allocated, i.e. corresponding to the origin port NP, and designating a logical channel on the internal line 6₁ to 6_{N} servicing the terminal TE directly or indirectly.

In step E7 the terminal TE continuously scans the line to which it is connected, which it has in fact been doing since the sending of the recognition cell C1 in step E2, to read the data fields of all ATM cells received thereon and thus to compare the twenty bytes of the terminal identifier location with its own terminal identifier NSAP. If the terminal TE recognizes the identifier NSAP in the acknowledgement cell C3 sent by the control center in step E6, it stores in memory the routing address VPI_{RT}/VCI_{RT} allocated to it by the control center 3 and included in the cell C3. The routing address VPI/VCI allocated is used systematically for any subsequent downlink call from the collective control center 3 to the terminal TE. Accordingly, provided that the terminal TE is not switched off or moved, dialog with the control center 3 is effected by means of cells sent in the downlink direction from the control center 3 to the terminal TE on the virtual channel corresponding to the routing address VPI_{RT}/VCI_{RT} allocated by the control center 3 to the terminal TE and by means of cells sent by the terminal TE to the control center 3 in the uplink direction on the virtual channel corresponding to a routing address VPI_{R}/VCI_{R} reserved for the control center 3 and thus known to the detectors 211 and 212 in the collective router 2.

After step E7, the terminal TE can go to the standby mode or be switched off.

If, subsequently, after activating it, the terminal TE requests the collective control center 3 to set up an outgoing call to a local called terminal in the installation or to a remote access network terminal, for a temporary or permanent connection, steps analogous to steps E1 to E7 are executed, but with the allocation of an available routing address VPI_{TE}/VCI_{TE} to the terminal TE for bidirectional communication with the local or remote terminal. In step E6, the processor 38 then further introduces the available routing address VPI_{TE}/VCI_{TE} into the data field of the cell C3, after the terminal identifier NSAP, which is then read and stored in memory in the calling terminal TE in step E7.

The processor 38 matches to the address VPI_{TE}/VCI_{TE} a routing address of an internal logical channel to the local terminal or of an external logical channel to the remote terminal and updates the addressing table 25 in the collective router 2 by means of an ATM configuration cell.

The processing of a directory consultation request for a predetermined function called by dialog between a calling terminal TDR and, essentially, the processor 38 and the database 39 in the collective control center 3 comprises the main steps A1 to A15 shown in FIG. 6.

After the step A1 of receiving an incoming cell CE sent by the terminal TDR and containing a routing address VPI_{R}/VCI_{R} reserved for a call set-up request, the processor 38 analyzes the first byte of the data field of the received incoming cell containing the number NP of the port of the collective router 21 and writes it into the database 39 in corresponding relationship with the identifier NSAP of the terminal TDR, in step A2. If the number NP designates a receive port internal to the collective installation 1, the calling terminal TDR is classed as a terminal internal to the collective installation in step A3 and is located at least at the level of an individual installation 4, or at the level of a local loop 6₂, 6_{N} if the terminal TDR is a shared terminal.

The processor 38 then verifies in step A4 that the control field CC of the incoming cell CE contains a class indicator ICDE designating at least one requested predetermined function that can be offered by a terminal, including the collective control center. If no class indicator ICDE is found in the received cell, the processor 38 performs a fuzzy analysis of the requested function or functions included in the control field CC of the data field CD of the incoming cell CE in step A5. The requested functions are expressed, for example, in the form of a list of keywords initially entered in the calling terminal TDR and included in the control field CC of the cell CE for the processor 38 to determine a class indicator ICDE using a predetermined algorithm. Thus in step A6 the processor 38 stores a requested service indicator ICDE deduced from the fuzzy analysis of the keywords in step A5 or from the precise indicator ICDE contained in the cell received in step A4.

In step A7, the processor 38 reads the class indicator IC of the calling terminal TDR and the access rights DA in the database 39 in correspondence with the identifier NSAP of the calling terminal TDR to verify if the indicator IC is compatible with the indicator ICDE.

The processor 38 analyzes the access rights DA of the calling terminal TDR compared to the class indicator ICDE of the requested service or terminal in step A8. If no access right is associated with the terminal TDR, or if the access rights DA read in the database 39 do not authorize the calling terminal TDR to access the requested service designated by ICDE, this failure to access a service (step A13) leads to a final step A14 for establishing of a report of the call, and where applicable the requested service, for example in the form of a docket that is stored and/or printed out, and to the end of the call in step A15.

In step A8, if the access rights DA of the calling terminal TDR are compatible with the requested class indicator ICDE, the processor 38 looks up in the database 39 all of the internal and external terminals, including the control center 3, whose class indicator IC designates a service offer profile covering the predetermined requested function or functions designated by the requested class indicator ICDE in step A9 and is therefore compatible with the access rights DA of the calling terminal TDR. A list of called terminals LPDE is drawn up by the processor 38, matching a class indicator IC and a location indicator IL to each identifier NSAP of a called terminal in the list. To be more precise, the processor 38 establishes a line of the list for each called terminal, the line containing the name and/or a graphical representation of the terminal, such as an icon or symbol, its location, and preferably the functions and applications that it offers, depending on its class indicator or indicators. If necessary, the processor 38 transmits this list in portions in one or more outgoing cells CS which are reassembled in the calling terminal TDR using an ATM adaptation layer (AAL) transfer mode.

The list LTDE is then displayed on the screen of the calling terminal TDR and/or presented in the form of a vocal announcement accompanied by selection addresses associated with the respective terminals from the list. In step A10, the user at the calling terminal conventionally selects one of the called terminals from the list, preferably the nearest called terminal, using a cursor key or by typing the address (number) associated with the selected called terminal TDES on the keyboard of the calling terminal. The address of the selected called terminal TDES is then transmitted from the terminal TDR to the collective control center 3 in an incoming cell CE.

When the list LTDE is consulted in step A10, if no called terminal TDES has been selected on the expiry of a predetermined time-out, or if the user presses a cancel key in step A11, the calling terminal TDR signals the end of the call to the processor 38, which executes step A14 and terminates the call in step A15.

Otherwise, in response to the address of the selected called terminal, the processor 38 provides the selected service in step A12, leading to a call between the router 2 and the selected called terminal TDES, including as the selected application in the control center 3, and a call between the router and the calling terminal TDR, through the correspondence of two routing addresses in the routing table 25. The end of the call is then processed in steps A14 and A15.

What we claim is:

1. A control center (3) for an ATM terminal installation (1) connected by a reserved telecommunication line (6_{R}) to a router (2) between external telecommunication lines (5₁-5_{M}) of ATM access networks and telecommunication lines (6₁, 6_{N}) internal to the installation servicing terminals (7, 13), characterized in that it comprises:
means (36, 39) for detecting and storing terminal identifiers (NSAP) and port numbers (NP) in incoming cells (CE) sent by the terminals and reserved for the control center, the port number of a terminal designating the internal line servicing at least the terminal,
means (36, 39) for allocating a class indicator (IC) to each terminal depending on functions offered by the latter and storing it, after a first activation of the terminal, and
means (38) for drawing up a list (LTDE) of terminals with the class indicators (IC) and location indicators (IL) of the terminals in order to transmit it in an outgoing cell (CS) from the control center to a calling terminal (TDR) that has sent an incoming cell containing a request for terminals offering at least one predetermined function (ICDE).

2. A control center according to claim 1, characterized in that the predetermined function (ICDE) is provided by the control center (3) itself.

3. A control center according to claim 1 or 2, comprising means (36) for matching an available routing address (VPI_{RT}/VCI_{RT}) and the port number (NP) of a terminal in order to include it in any outgoing cell (CS) sent from the control center to the terminal.

4. A control center according to claim 3, comprising means (36, 39) for periodically polling the terminals and storing their operating status in order to make available a routing address (VPI_{RT}/VCI_{RT}) reserved for a call from the control center to a stopped terminal.

5. A control center according to any of claims 1 to 4, characterized in that the request for terminals offering a predetermined function takes the form of a class indicator (ICDE) included in a control field (CC) of the data field (CD) of an incoming cell (CE).

6. A control center according to any of claims 1 to 5, characterized in that the request for terminals offering at least one predetermined function takes the form of keywords entered into the calling terminal (TDR) and included in a control field (CC) of the data field (CD) of an incoming cell (CE), and a list drawing-up means (38) deduces (A5) a class indicator (ICDE) from a fuzzy analysis of the keywords.

7. A control center according to any of claims 1 to 6, comprising means (38, 39) for allocating to a terminal a location indicator (IL) only matching the port number (NP) designating the internal line servicing the terminal.

8. A control center according to any of claims 1 to 7, characterized in that it comprises means (38, 39) for storing location indicators (IL) respectively associated with the terminals and entered in the control center after activating the respective terminals in the terminal installation.

9. A control center according to any of claims 1 to 8, comprising means (38, 39) for storing respective location indicators (IL) associated respectively with the terminals, entered into the terminals and included in a control field (CC) of the data field (CD) of an incoming cell (CE) at the time of activating the terminals in the terminal installation.

10. A control center according to any of claims 1 to 9, characterized in that the list of terminals (LTDE) contains, for each terminal, the name of and/or a graphical representation of the terminal, its location and a designation of at least one function offered by the terminal, together with an address of the terminal which is selectable in the calling terminal (TDR).

11. A control center according to any of claims 1 to 10, comprising means (38, 39) for allocating to each terminal access rights (DA) entered into the control center after first activating the terminal in the terminal installation, and storing them, in order to compare (A8) the access rights of the calling terminal (TDR) with the class indicators (IC) stored and to draw up (A9) the list (LTDE) only for terminals offering class indicators (IC) compatible with the access rights of the calling terminal and covering the predetermined function (ICDE).

12. A control center according to any of claims 1 to 11, comprising means (37) for selecting, managing and controlling home automation terminals in the terminal installation.

13. A control center according to any of claims 1 to 12, comprising means (31-35) for processing incoming cells (CE, CS) to the control center and transmitting outgoing cells (CS) from the control center in an order of priority of the routing addresses (VPI_{R}, VCI_{R}) that the cells contain.

14. A control center according to any of claims 1 to 12, comprising a table memory (33) for matching priority indicators (IP1-IPK) and routing addresses (VPI_{R}/VCI_{R}) contained in the routing address field of cells (CE, CS) incoming to and outgoing from the control center and reserved for calls with the control center, means (31) for comparing the routing address fields of the incoming cells (CE) to the reserved routing addresses read in the table memory (33), first buffers (321, 32K) for storing each incoming cell (CE) respectively as a function of the priority indicator corresponding to the routing address contained in the incoming cell, cell processing means (36, 37, 38) for processing the incoming cells by starting with those contained in the first buffers addressed by the highest priority indicators, means (38) for comparing the routing address fields of the outgoing cells (CS) produced by the processing means to the reserved routing addresses read in the table memory (33), second buffers (341-34K) for storing each outgoing cell (CS) respectively as a function of the priority indicator matching the routing address contained in the outgoing cell, and means (35) for sending the outgoing cells by starting with those contained in the second buffers associated with the highest priority indicators.

15. An ATM terminal installation (1) comprising a control center (3) and a router (2) which is connected to the control center by a reserved telecommunication line (6_{R}), to ATM access networks (RA₁-RA_{M}) by a plurality of external telecommunication lines (5₁-5_{M}) and to ATM terminals (7) by internal telecommunication lines (6₁-6_{N}), characterized in that the router (2) routes to the reserved line (6_{R}) cells which contain reserved routing addresses (VPI_{R}/VCI_{R}) and routing addresses unknown to a routing table (25) stored in the router and which are transmitted by the terminals (7) and the access networks (RA₁-RA_{M}), and routes cells containing routing addresses (VPI/VCI) known by the routing table (25) between the internal lines and the external lines and between the internal lines, and
the control center (3) comprises:
means (38, 39) for managing the routing table (25) in order to process cells containing reserved routing addresses (VPI_{R}/VCI_{R}) routed to the reserved line (6_{R}) and to match unreserved routing addresses (VPI/VCI) included in cells received by the router (2) to unreserved routing addresses to be included in cells to be sent from the router,
means (36, 39) for detecting and storing terminal identifiers (NSAP) and port numbers (NP) in incoming cells (CE) sent by the terminals an reserved for the control center, the port number of a terminal designating the internal line servicing at least the terminal,
means (36, 39) for allocating a class indicator (IC) to each terminal depending on functions offered by the latter and storing it, after a first activation of the terminal, and
means (38) for drawing up a list (LTDE) of terminals with the class indicators (IC) and location indicators (IL) of the terminals in order to send it in an outgoing cell (CS) from the control center to a calling terminal (TDR) that has sent an incoming cell containing a request for terminals offering at least one predetermined function (ICDE).

16. An installation according to claim 15, characterized in that the router (2) comprises means (211, 212, 231, 232) for detecting reserved routing addresses (VPI_{R}/VCI_{R}) and routing addresses unknown to the routing table (25) in cells (Cl) received by the router, means (211, 212, 231, 232, 25) for substituting reserved routing addresses for the unknown routing addresses in the received cells, means (213, 233) for marking the data field of each cell containing a reserved routing address with a number (NP) of a port of origin (20ₙ, 22ₘ) of the router via which the cell was received, and means (241, 242) for routing all the marked cells (C2) to the control center (3) via the reserved line (6_{R}).

17. An installation according to claim 15 or 16, comprising at least one individual terminal installation (4) connected to a respective internal line (6ₙ) and including terminals (7), a broadcaster (8D) for broadcasting cells received via the respective internal line to the terminals of the individual installation, and a collector for collecting cells produced by the terminals of the individual installation and transmitting them on the respective internal line to the router (2).

18. An installation according to any of claims 14 to 17, comprising at least one terminal (13) shared between individual installations (4) and connected to the router (2) by a respective internal telecommunication line (6₂).

19. An installation according to any of claims 14 to 18, comprising at least one replicator (11, 15) servicing by broadcasting a plurality of terminals (12, 14) and connected to the router (2) by a respective internal telecommunication line (6ₙ₊₁, 6₁).
